(19) United States
(12) Patent Application Publication
(10) Pub. No.: US 2018/0046577 A1
(43) Pub. Date: Feb. 15, 2018

(54) THREAD BLOCK MANAGING METHOD, WARP MANAGING METHOD AND NON-TRANSITORY COMPUTER READABLE RECORDING MEDIUM CAN PERFORM THE METHODS

(71) Applicants: National Taiwan University, Taipei (TW); MEDIATEK INC., Hsin-Chu (TW)

(72) Inventors: Li-Jhan Chen, New Taipei City (TW); Po-Han Wang, Taipei City (TW); Chia-Lin Yang, Taipei City (TW)

(21) Appl. No.: 15/485,241

(22) Filed: Apr. 12, 2017

Related U.S. Application Data
(60) Provisional application No. 62/374,929, filed on Aug. 15, 2016.

(51) Int. Cl. G06F 12/0846; G06F 9/50; G06F 12/084

(52) U.S. Cl. CPC G06F 12/0848; G06F 12/084; G06F 9/5016; G06F 9/5061; G06F 2212/62; G06F 2212/60

(57) ABSTRACT

A thread block managing method, applied to an electronic apparatus comprising a memory and a cache, comprising: (a) transforming memory addresses for the memory to cache addresses of the cache; (b) mapping a memory access range for a thread block to the cache addresses to generate a block access range; (c) calculating block locality between the thread blocks according to the block access range; and (d) allocating the thread blocks to a plurality of multi-processors depending on the block locality.

### CROSS REFERENCE TO RELATED APPLICATIONS

This application claims the benefit of U.S. Provisional Application No. 62/374,929, filed on Aug. 15, 2016, the contents of which are incorporated herein by reference.

### BACKGROUND OF THE INVENTION

### 1. Field of the Invention

The present invention relates to a thread block managing method and a warp managing method, and a non-transitory computer readable recording medium can perform the methods, and particularly relates to a thread block managing method can compute block locality and a warp managing method can compute warp locality, and a non-transitory computer readable recording medium can perform the methods.

### 2. Description of the Prior Art

FIG. 1 is a block diagram illustrating a GPU (Graphics Processing Unit) for prior art. As illustrated in FIG. 1, the GPU 100 comprises a block scheduler 101, a plurality of multi-processors M1 . . . Mn, a cache 103 and a memory 105.

A GPU kernel is consist of multiple threads, and collection of threads are grouped as warps. Also, multiple warps are combined to a thread block. Thread blocks are dispatched to the multi-processors M1 . . . Mn through the block scheduler 101, after transmitted to the memory 105 and the cache 103. Thread blocks are dispatched to the multi-processors M1 . . . Mn in a round-robin manner, which means the thread blocks are sequentially dispatched to the multi-processors M1 . . . Mn. Other details for the GPU 100 are known by persons skilled in the art, thus are omitted for brevity here.

The maximum number of thread block can reside in a multi-processor depends on: Shared memory (113) usage/per thread block, Register (109) usage/per thread block, the total number of thread blocks, and the total number of threads. Once the processing of a thread block is finished, the block scheduler 101 would dispatch another thread block to that multi-processor until all thread blocks in a kernel have been processed.

Accordingly, the GPU 100 always has limited cache resources for each thread. For example, for a Kepler GPU, up to 2048 threads per multi-processor share a 48 KB cache. Accordingly, each block thread only has 24 bytes cache, which is much less than a CPU thread (8˜16 KB per thread). Also, the GPU's block scheduler is not aware of cache access locality, thus the cache cannot be reused even if cache access locality exists.

### SUMMARY OF THE INVENTION

One objective of the present invention is to provide a thread block managing method can compute block locality for thread blocks.

Also, another objective of the present invention is to provide a warp managing method can compute warp locality for warps.

One embodiment of the present invention discloses a thread block managing method, applied to an electronic apparatus comprising a memory and a cache, comprising: (a) transforming memory addresses for the memory to cache addresses of the cache; (b) mapping a memory access range for a thread block to the cache addresses to generate a block access range; (c) calculating block locality between the thread blocks according to the block access range; and (d) allocating the thread blocks to a plurality of multi-processors depending on the block locality.

Another embodiment of the present invention discloses a warp managing method applied to warps in a thread block, wherein each of the warps comprises a plurality of threads. The warp managing method comprises: separating the thread block to a plurality of regions; determining region vectors for the warps according to the regions; separating each one of the regions to a plurality of sub-regions; determining sub-region vectors for the warps according to the sub-regions; determining warp locality for the warps according to the region vectors and the sub-region vectors; dividing the warps into an active group and a pending group, wherein the warps in the active group are executed before the warps in the pending group; demoting the warp which is in the active group and reaches a latency stall over a predetermined level to the pending group; and promoting the warp which is in the pending group and has the highest warp locality with other one of the warps in the active group.

The above-mentioned methods can be executed via at least one program stored in a non-transitory computer readable medium such as a storage unit.

In view of above-mentioned embodiments, block locality for thread blocks and warp localities are computed before the thread blocks or the warps are executed. Accordingly, the cache can be efficiently used.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a GPU (Graphics Processing Unit) for prior art.

FIG. 2 is a block diagram illustrating a GPU according to one embodiment of the present invention.

FIG. 3A, FIG. 3B, are schematic diagrams illustrating an example to calculate memory addresses for threads.

FIG. 4A, FIG. 4B, are schematic diagrams illustrating an example to calculate memory access ranges for thread blocks.

FIG. 5-FIG. 8 are schematic diagrams illustrating how to calculate block locality, according to embodiments of the present invention.

FIG. 9 is a flow chart illustrating a thread block managing method according to one embodiment of the present invention.

FIG. 10-FIG. 12 are schematic diagrams illustrating an example for calculating warp locality.

FIG. 13 is a block diagram illustrating a two level warp scheduler according to one embodiment of the present invention.

FIG. 14 is a flow chart illustrating operations for the two level warp scheduler illustrated in FIG. 13.

FIG. 15 is a schematic diagram illustrating the warp locality table.

FIG. 16 is a schematic diagram illustrating an example for computing the warp locality.

FIG. 17 is a schematic diagram illustrating a warp managing method according to one embodiment of the present invention.

### DETAILED DESCRIPTION

In following descriptions, several embodiments are provided to explain the concept of the present invention. Please note these embodiments are only for explaining and do not mean to limit the scope of the present invention. Furthermore, the elements illustrated in these embodiments can be implemented by hardware (ex. a circuit) or a combination of hardware and software (ex. a program installed to processing unit).

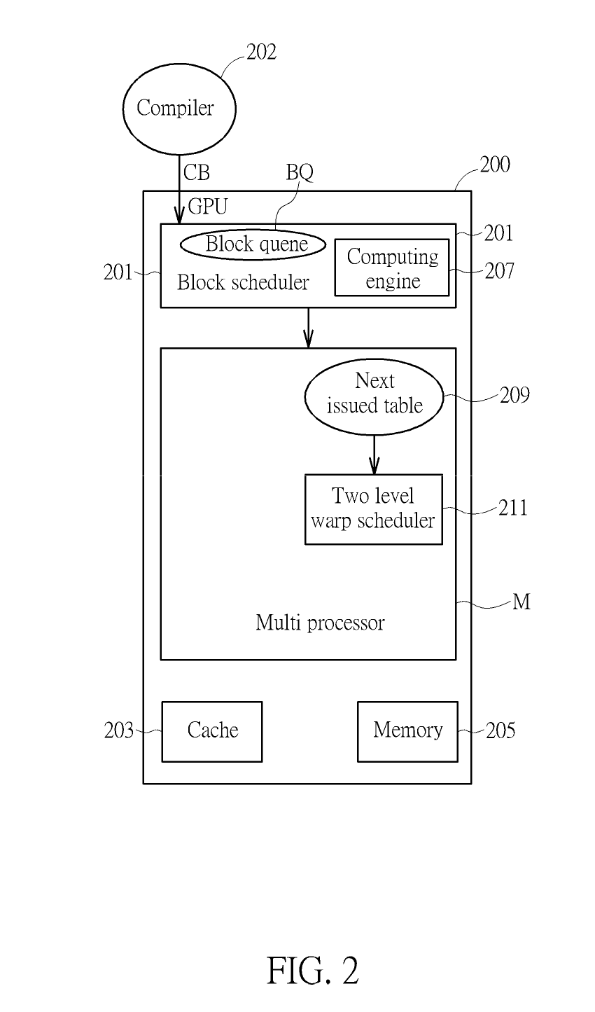

FIG. 2 is a block diagram illustrating a GPU according to one embodiment of the present invention. As illustrated in FIG. 2, the GPU 200 comprises a block scheduler 201, a multi-processor M, a cache 203 and a memory 205. Please note other multi-processors and some devices for the GPU are not illustrated here.

In the embodiment, a compiler 202 is provided to extract address calculation codes from kernel programs during compilation and generate an address calculation binary CB. After that, the GPU driver not illustrated here passes the binary to the block scheduler 201 when a GPU kernel is launched. In one embodiment, the calculating engine 207 is a small, in-order CPU in the block scheduler 201 and is utilized to run the locality-aware scheduling algorithm, which will be described for more detail in following descriptions.

First, each thread block in the block queue BQ is analyzed to obtain its memory access range based on the address calculation code. After that, when one of multi-processors completes execution of a thread block, a predetermined thread block in the next issued table is dispatched to the multi-processor M. At the same time, the block scheduler 201 decides what the thread block is issued next to the SM. Finally, after the next issued thread block is determined, memory access range of each warp is calculated and then the information is stored into the next issued table 209 to be utilized by the warp schedulers. In one embodiment, the warp scheduler is a two level warp scheduler 201, which will be described later.

In following descriptions, the details for acquiring memory access ranges for thread blocks are described. In one embodiment, the above-mentioned compiler 202 is a GPGPU (General-Purpose Graphics Processing Unit) compiler, which is modified to extract the address calculation code, such that the block scheduler 201 can calculate the memory access range based on the address calculation binary CB. A GPGPU program is composed of one or more kernels, and each kernel is an array of threads which run the same program code on different data. The mapping between thread IDs and data can be derived through simple mathematics, since threads often operate on structural data, such as one or two dimensional arrays, in regular GPGPU programs.

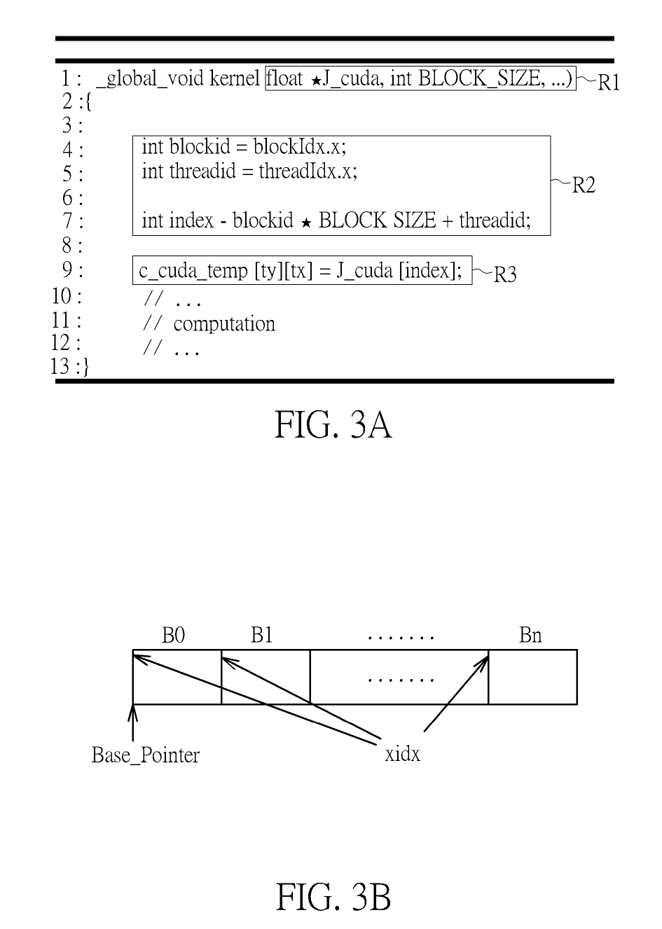

For instance, FIG. 3A shows a simplified kernel function, and the code segments that calculate the mapping between thread ID and data are indicated by rectangle boxes R1, R2 and R3. The compiler 202 can easily extract the address calculation code, i.e., the code that is utilized to calculate the index of the input data array (rectangle box R2), from a kernel function, and use the address calculation code and the base address of the data array pointer to generate the address calculation binary. The rectangle box R1 indicates the constant value and the data array pointer. Also, the rectangle box R3 indicates the access to the data array.

At run-time, the block scheduler 201 can use the abovementioned calculation binary CB and the thread ID to calculate the memory addresses accessed by an arbitrary thread, as shown in FIG. 3B. FIG. 3B can be shown as:

int xidx=blockID*BLOCK_SIZE+threadID

Int data=*(Base_Pointer+xidx)

That is, the parameter int xidx can be acquired based on which is the thread, and which is the block that the thread is located. For example, the thread is a first thread in a second thread block. Thus the memory address for the thread is 1*block size+base pointer. The base pointer indicates the starting address for thread blocks.

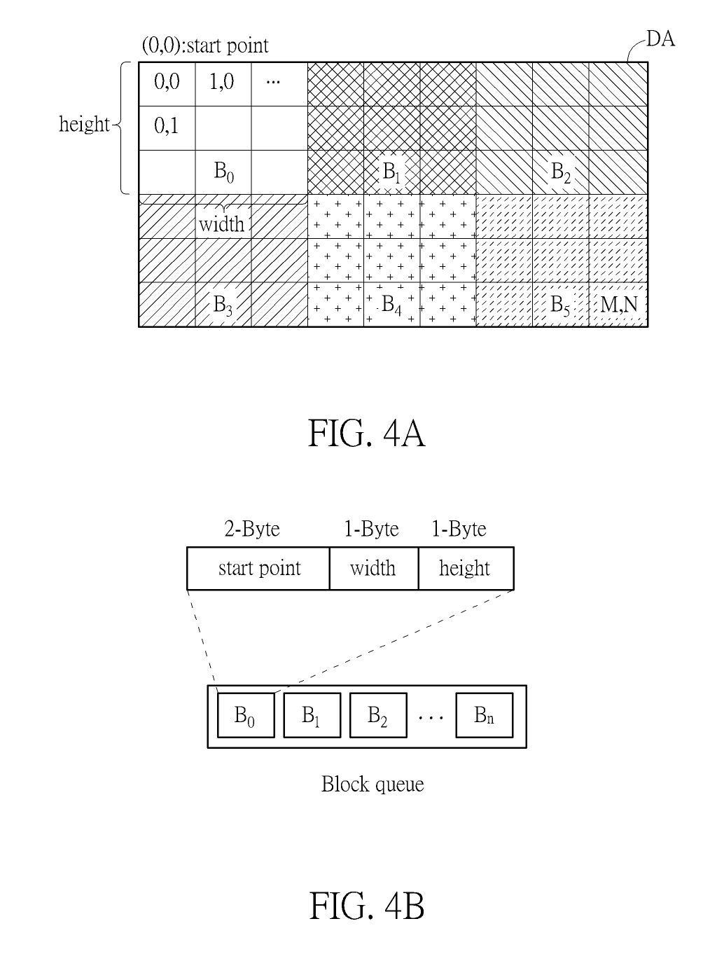

After the memory addresses for the threads are acquired, the memory access range of each thread block can be accordingly calculated. More specifically, the memory access range of each thread block can be represented by a rectangle and stored in the block queue (i.e. the block queue BQ in FIG. 2), since threads in regular GPGPU applications often access contiguous memory regions, such as linear 1D or 2D arrays. FIG. 4A shows an example of the rectangular thread block level access range. The address of the start point, i.e., the upper-left address, can be calculated by the memory address of the first thread in the thread block, and the width/height can be calculated by the address differences between the first and the last thread in the thread block. Information about the memory access range for thread blocks, including the start point, width, and height, are stored in the block queue, as illustrated in FIG. 4B.

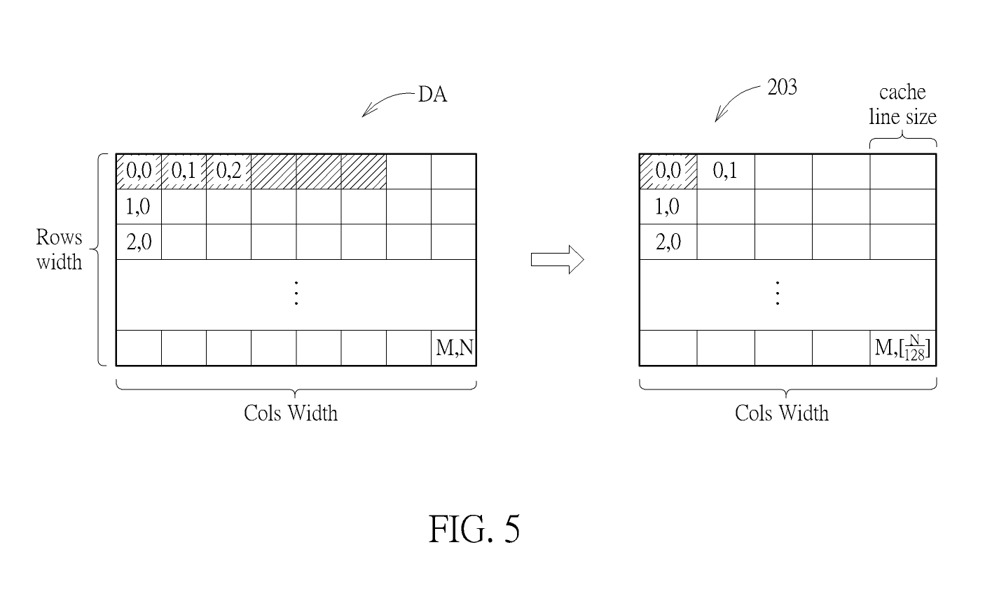

After memory access ranges for thread blocks are acquired, the block locality between the thread blocks can be calculated. That is, it can be calculated that if any different thread blocks share the same memory access range. FIG. 5-FIG. 7 are schematic diagrams illustrating how to calculate block locality.

In one embodiment, in order to calculate the block locality, the coordination of cache lines in the cache 203 to represent the access range rectangles of the thread blocks. As shown in FIG. 5, the memory addresses of the data array DA (corresponding to the memory), which has M*N bytes can be transformed into the corresponding cache addresses for the cache line. For example, in a cache with 128-byte cache lines, memory addresses from (0,0) to (127, 0) belong to the cache line (0,0) and memory addresses (128,1) to (255,1) belong to the cache line (1,1). Through the address transformation, the start point, width, and height of each thread block can be represented in cache line coordination, as indicated by the bold rectangle.

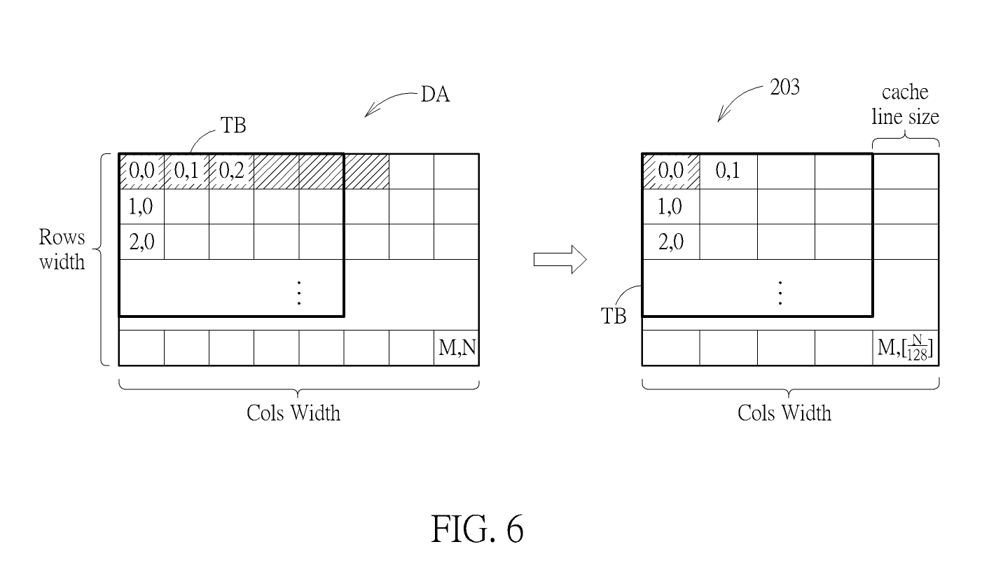

As above-mentioned, the memory access range for the thread block is already acquired. Accordingly, a memory access range for a thread block can be matched to the cache addresses to generate a block access range. As illustrated in FIG. 6, the block access range can be determined by: an upper left position (i.e. a first thread in the thread block); widthₓ and width_{y}, which is defined as the memory access range in x/y axis for a thread block (last thread in the thread block).

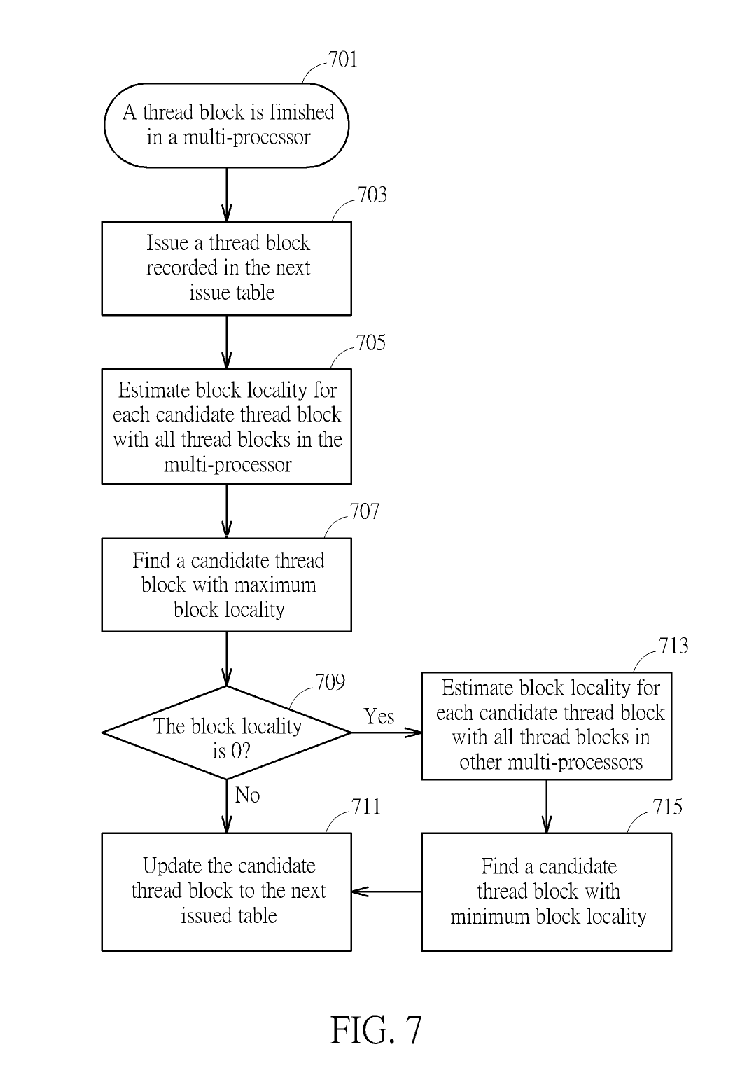

FIG. 7 is a flow chart for determining which thread block should be dispatched. Once the execution of a thread block is completed on a multi-processor, the thread block scheduler allocates the predetermined thread block recorded in the next issued table to the multi-processor. After that, the thread block dispatching is triggered to decide what thread block to be dispatched to the multi-processor. The thread block is determined by considering the overall block locality (L_all), i.e. the summation of block locality between the candidate thread block and all the running thread blocks on the multi-processor. The block locality of any two thread blocks (L_pair) is defined as the summation of the overlapped data access range in all data arrays between them.

FIG. 7 comprises following steps:

Step 701

A thread block is finished in a multi-processor.

Step 703

Issue a thread block recorded in the next issue table.

Step 705

Estimate block locality for each candidate thread block with all thread blocks in the multi-processor.

Step 707

Find a candidate thread block with maximum block locality.

Step 709

Check if the block locality is 0. If Yes, go to step 713, if not, go to step 711.

Step 711

Update the candidate thread block to the next issued table.

Step 713

Estimate block locality for each candidate thread block with all thread blocks in other multi-processors.

Step 715

Find a candidate thread block with minimum block locality and then go to step 711.

The meaning for steps 709-715 is: If the blocks in a multi-processor have low block locality, no block in this multi-processor is selected as the next issued block. On the opposite, the block in another multi-processor and has a minimum block locality with the candidate block is selected as the next issued block. By this way, the initial sequence for blocks which have no block locality but in the same multi-processor will not be disturbed.

In view of above-mentioned descriptions, the meaning of the steps 709-715 can be summarized as: a first thread block among the thread blocks and a second thread block among the thread blocks are dispatched to the same one of the multi-processor. The block locality between other ones of the thread blocks and the first thread block in the same multi-processor is lower than a first predetermined value (ex. equals to 0), and the block locality between the first thread block and the second thread block is lower than block locality between other ones of the thread blocks in other multi-processors and the first thread block.

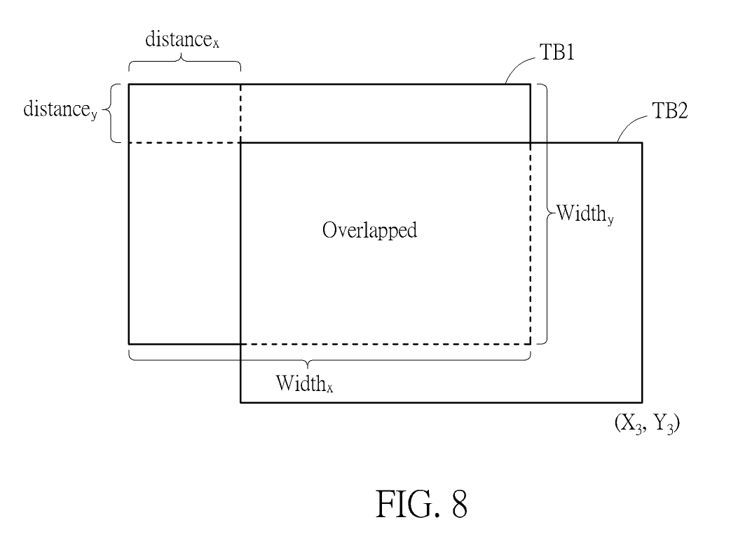

For each thread block, the overlapped block access range is calculated by the following steps, as illustrated in FIG. 8:

1. distanceₓ and distance_{y} are the differences in x-axis and y-axis between the start points of two thread blocks.

2. If distanceₓ>thread block's width or distance_{y}>thread block's height, there is no overlapped block access range, indicating that there is no locality between these two thread blocks.

3. Otherwise, the overlapped area is (thread block's width−distanceₓ), (thread block's height− distance_{y}), which is equal to the number of cache lines shared between these two thread blocks.

Based on the estimation of block locality, the thread block scheduler dispatches the thread block with a maximum L_all to the multi-processor, as shown in FIG. 7. When all the candidate thread blocks have no block locality on this multi-processor, the thread block with a minimum L_all on other multi-processors is selected, so that the degradation of block locality on other multi-processors can be avoided.

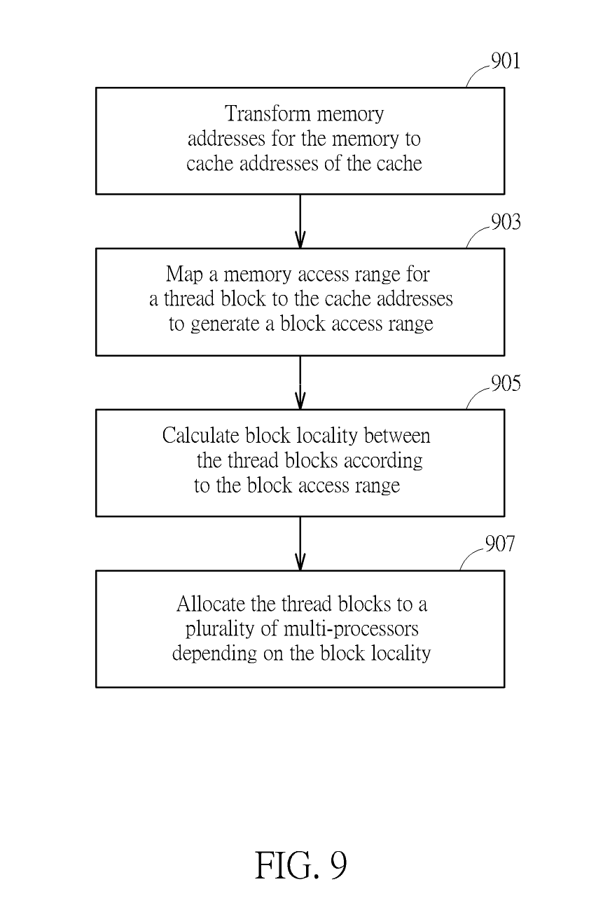

In view of above-mentioned embodiments, a thread block managing method can be acquired, which is applied to an electronic apparatus comprising a memory (ex. 205 in FIG. 2) and a cache (ex. 203 in FIG. 2), as illustrated in FIG. 9. FIG. 9 comprises following steps:

Step 901

Transform memory addresses for the memory to cache addresses of the cache (ex. FIG. 5).

Step 903

Map a memory access range for a thread block to the cache addresses to generate a block access range (ex. FIG. 6).

Step 905

Calculate block locality between the thread blocks according to the block access range (ex. FIG. 8)

Step 907

Allocate the thread blocks to a plurality of multi-processors depending on the block locality (ex. FIG. 7).

Other detail steps can be acquired in view of above-mentioned embodiment, thus are omitted for brevity here.

In following descriptions, the calculating for warp access ranges according to embodiments of the present invention will be described.

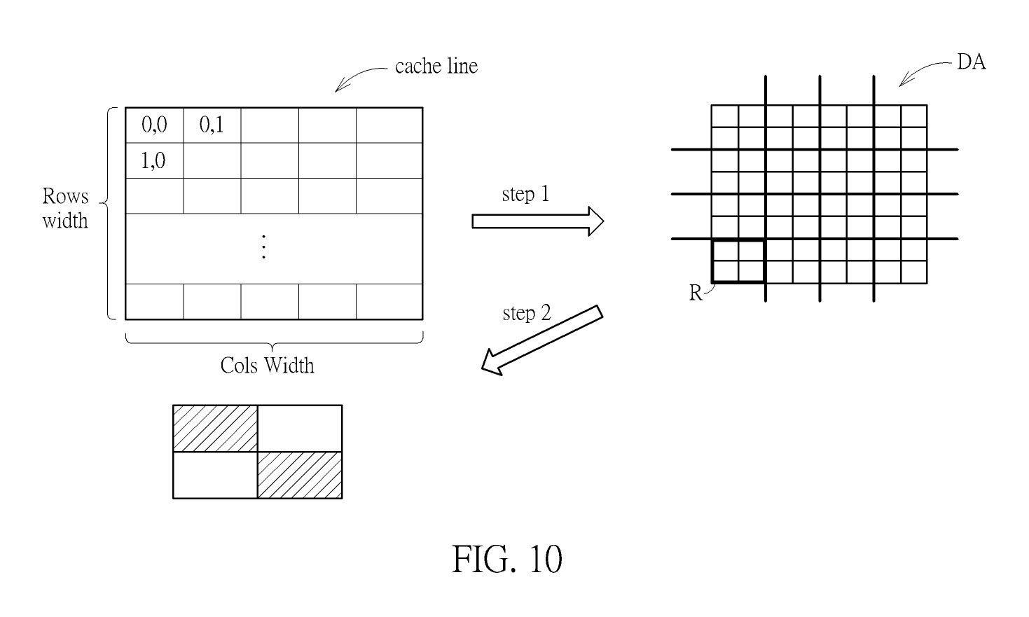

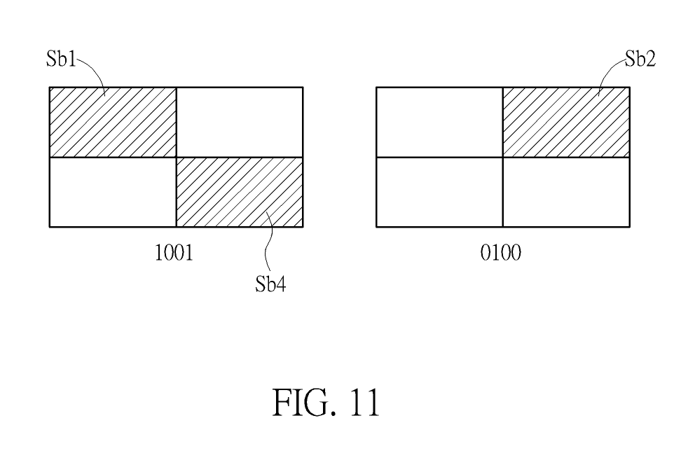

Unlike the block access range of a thread block, the warp access range of a warp always does not have a fixed shape, so it cannot be represented as the start point, width, and height, as illustrated in above-mentioned embodiments. Instead, the warp access range of a warp can be represented as a bit-vector. In the bit-vector, each bit is used to represent the access status of a unique cache line. Bit0 means that the cache line is not accessed by the warp and bit 1 means that the cache line is accessed by the warp. However, the one bit representation is impractical due to the huge working set in the kernel. Hence, a method for calculating warp access ranges is described in FIG. 10 and FIG. 11. The method comprises following two steps:

Step 1

The data array is partitioned into 2̂U small regions where each region is represented by a region vector with U bits. In this example, U=4. Then, each thread block could get a U-bit region vector by mapping its memory access range to the data array. As shown in FIG. 10, the data array DA is partitioned into 16 regions. If the access range of a thread block is fallen into the region R, and the 4-bit region vector becomes 1100, since it is a 12^{th} region.

Each region is further partitioned into V sub-regions where each sub-region is represented by a sub-region vector with V bits. In this embodiment, V=4. Then, the warp could get a V-bit sub-region vector by mapping its memory access range to the sub-region. As shown in FIG. 11, each region is partitioned into 4 sub-regions. Each sub-region uses 1 bit to indicate whether it is accessed by the warp or not. If a warp accesses the sub-regions Sb1, Sb4, the 4-bit sub-region vector becomes 1001. In another example, if a warp accesses the sub-region Sb2, the 4-bit sub-region vector becomes 0100.

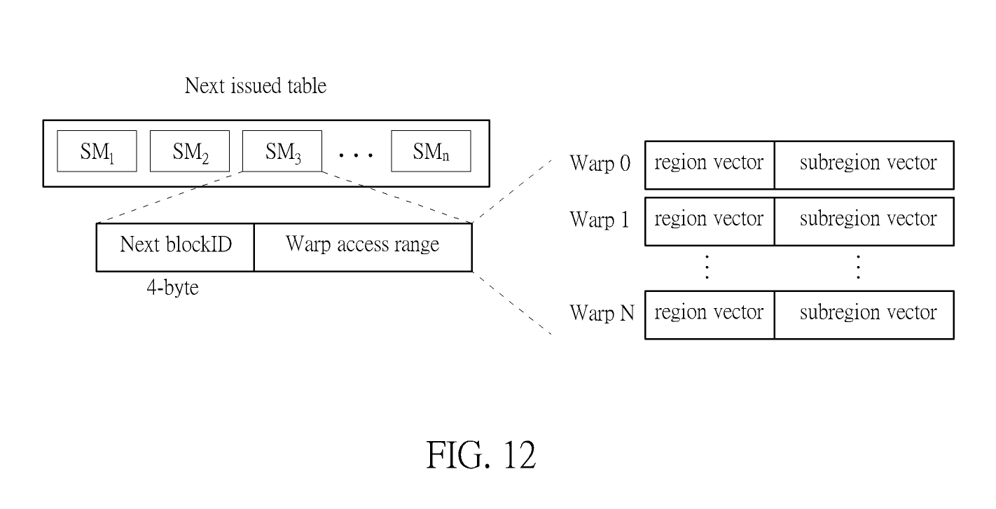

Combine the region vector of the thread block and the sub-region vector of the warp, the warp access range can be represented as U (length of region vector)+V (length of sub-region vector) bits and the information is stored in the Next Issue Table, as illustrated in FIG. 12.

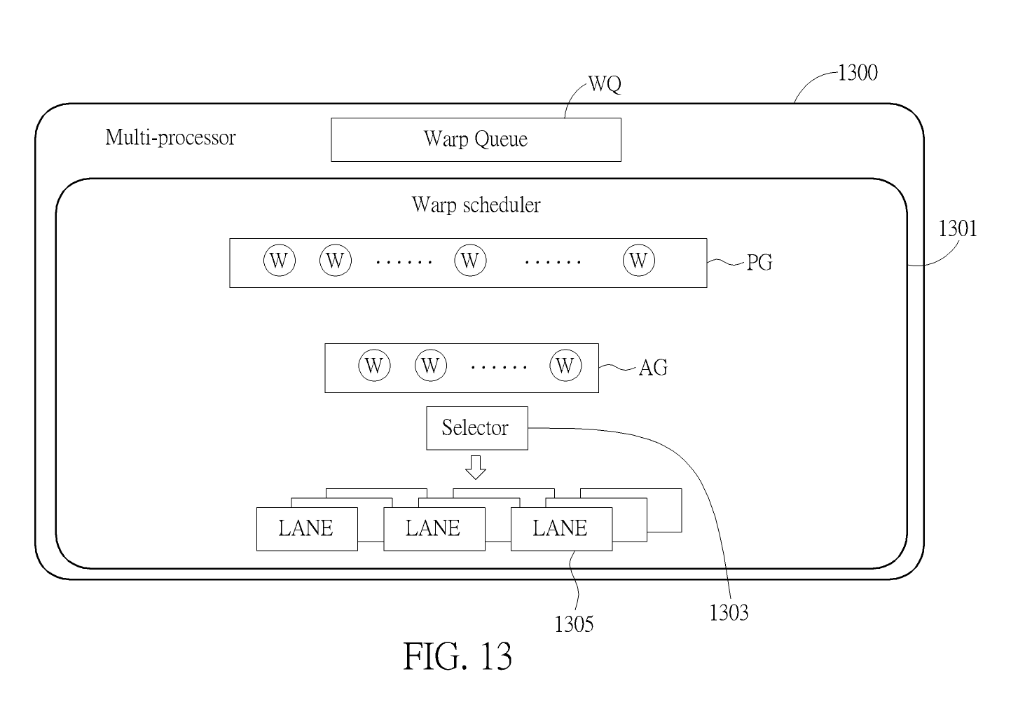

In order to capture the locality at warp-level, warps with data locality should be put together in a single level such that the shared cache lines between them could be used as many times as possible and other warps with no data locality are put in the second level for hiding long memory access latencies. Based on the above thought, a two-level warp scheduler is provided, which is illustrated in FIG. 13.

FIG. 13 is a schematic diagram illustrating a two level warp scheduler according to one embodiment of the present invention. In the multi-processor 1300, an additional warp queue WQ is introduced to store the access range of the running warps on the multi-processor 1300 as well as warp locality, which represents the number of cache lines shared between warps. The warp access range is updated by the thread block scheduler and the warp locality is computed by the warp scheduler during execution. The two-level warp scheduler 1301 divides all the running warps in a multi-processor 1300 into two groups: an active group AG and a pending group PG. The warps in the active group AG are executed by the lane 1305 before the warps in the pending group PG. The warp scheduler 1300 selects warps in the active group AG for execution until any active warp has reached a long-latency stall, such as an off-chip memory access. The stall warp is demoted to the pending group PG and a warp in the pending group which has the highest warp locality with other warps in the active group AG is promoted.

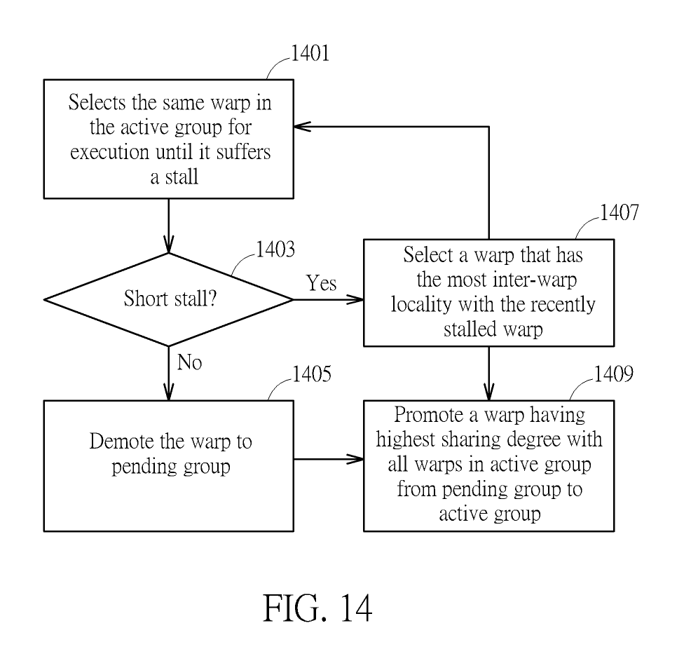

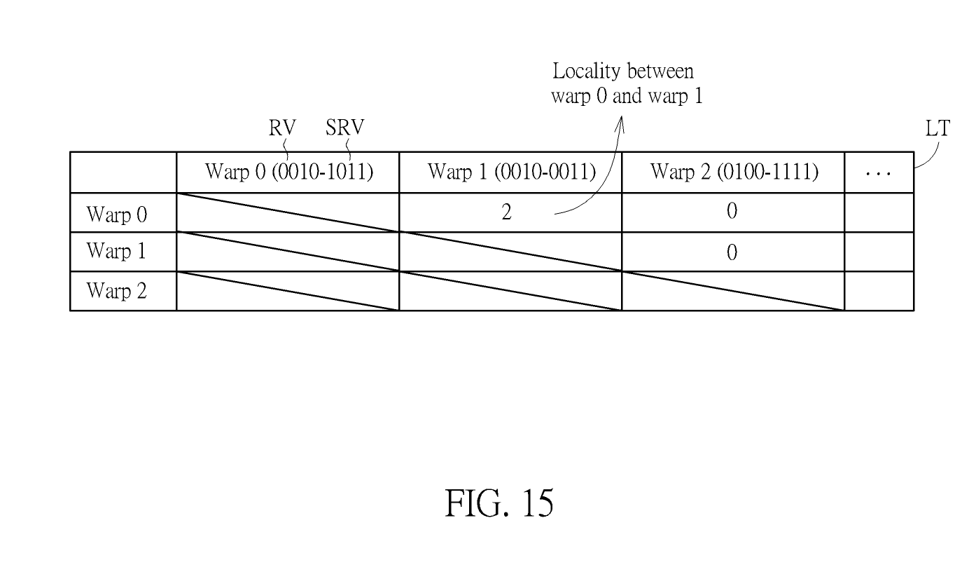

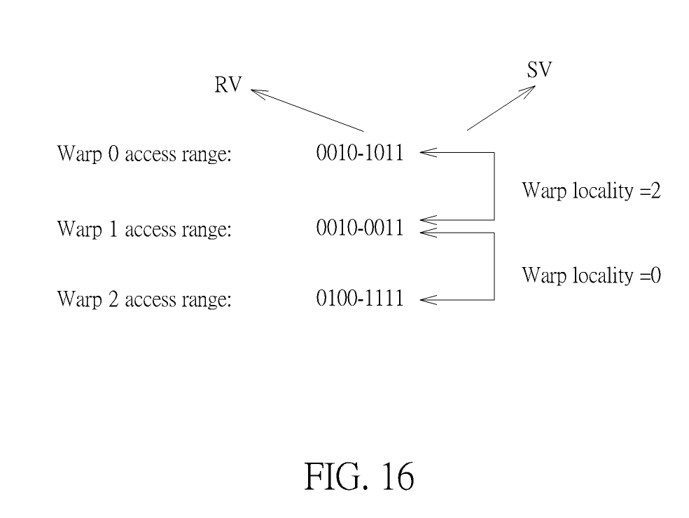

FIG. 14 is a flow chart illustrating operations for the two level warp scheduler illustrated in FIG. 13. FIG. 15 is a schematic diagram illustrating the warp locality table. Also, FIG. 16 is a schematic diagram illustrating an example for computing the warp locality.

The steps illustrated in FIG. 14 can be shown as below:

1. The warp scheduler selects the same warp in the active group for execution until it suffers a stall (step 1401).

2. Determine if the stall is short or not (step 1403). If the stall is a short one, such as pipeline stalls, the warp scheduler would select a warp that has the highest warp locality with the recently stalled warp (step 1407).

3. Otherwise, the warp has reached a long-latency stall and is demoted to the pending group (step 1405). At the same time, the warp scheduler would promote a warp, which has the highest warp locality with all warps in the active group, from the pending group to the active group (Step 1409).

The warp locality is kept in a locality degree table LT, as shown in FIG. 15. Each entry in the locality degree table represents the warp locality of the corresponding two warps. For instance, warp locality between warp 0 and warp 1 is stored in the entry (0, 1).

The warp locality between the two warps can be computed by comparing their warp access ranges with following two steps. First, check whether the region-vector between the two warps are the same, if they have different region-vectors, there is no warp locality among them. As shown in FIG. 16, warp 1 and warp 2 have different region-vectors RV, which means that they access different region in the data array, so the warp locality becomes 0. Otherwise, the warp locality is the number of same bit 1 in the sub-region vector SRV. As shown in FIG. 16, warp 0 and warp 1 have the same region-vectors SRV, so the warp locality becomes 2 because there are 2 of the same bit 1 in the sub-region vector (1001).

However, starvation issue may occur when some warp naturally has no data locality with other warps. Once a warp starves, the other warps within the same thread block cannot leave the multi-processor until the starved warp is finished, which leads to performance degradation. In one embodiment, a simple timeout solution is adopted to solve the starvation issue. Each thread block is given an age when it is assigned to the multi-processor. We detect the starvation happened when Age_{new}−Age_{current}>2K, which means the warp is suspended for a long time. K is the max number of thread block in the multi-processor. Once any starvation of a warp is detected, the warp is severed as the highest priority.

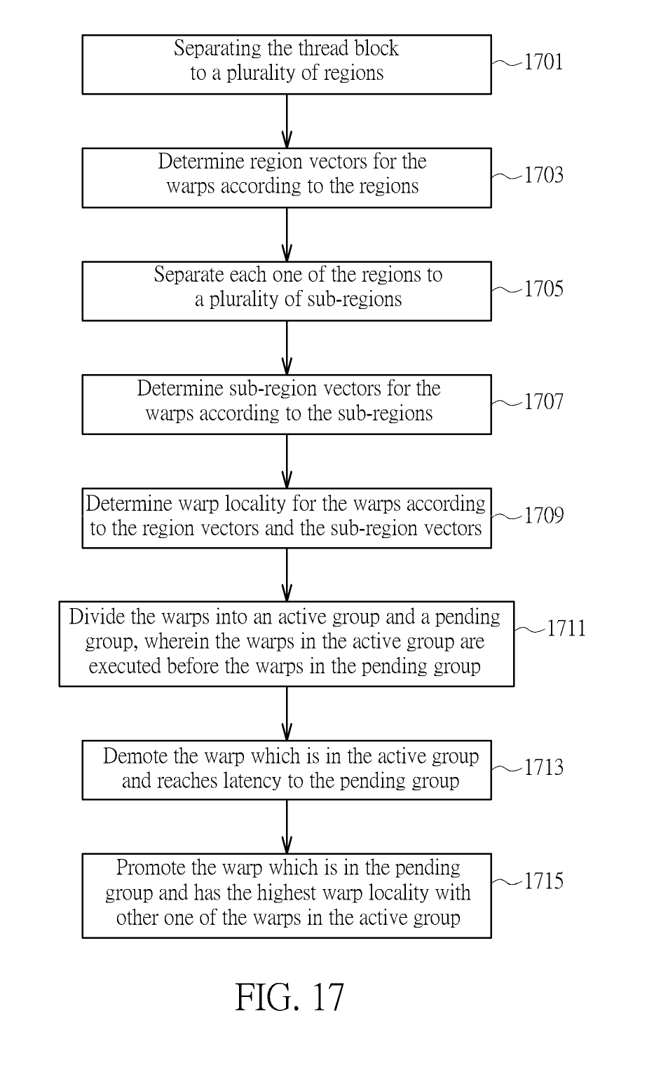

In view of above-mentioned embodiments in FIG. 13-FIG. 16, a warp managing method can be acquired, which is illustrated in FIG. 17. FIG. 17 comprises following steps:

Step 1701

Separating the thread block to a plurality of regions.

Step 1703

Determine region vectors for the warps according to the regions.

Step 1705

Separate each one of the regions to a plurality of sub-regions.

Step 1707

Determine sub-region vectors for the warps according to the sub-regions. Steps 1701-1707 correspond to FIG. 10 and FIG. 11.

Step 1709

Determine warp locality for the warps according to the region vectors and the sub-region vectors. Step 1709 corresponds to FIG. 12 and FIG. 16.

Step 1711

Divide the warps into an active group and a pending group, wherein the warps in the active group are executed before the warps in the pending group.

Step 1713

Demote the warp which is in the active group and reaches a long latency stall (i.e. reaches a latency stall over a predetermined level) to the pending group.

Step 1715

Promote the warp which is in the pending group and has the highest warp locality with other one of the warps in the active group. Steps 1711-1715 correspond to FIG. 13 and FIG. 14.

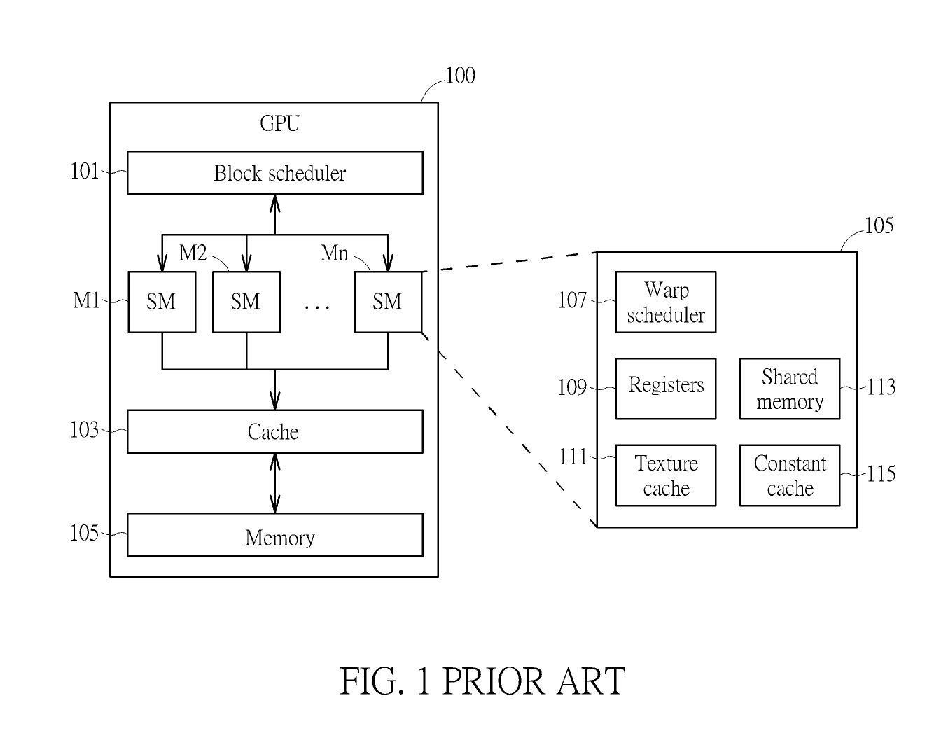

Please note the warp managing method can be combined to the thread block managing method illustrated in FIG. 1-FIG. 9, but can be independently used.

It will be appreciated that although the above-mentioned methods are applied to a GPU, the methods can be applied to other devices as well. Besides, the above-mentioned methods can be executed via at least one program stored in a non-transitory computer readable medium such as a storage unit.

In view of above-mentioned embodiments, block locality for thread blocks and warp localities are computed before the thread blocks or the warps are executed. Accordingly, the cache can be efficiently used.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thread block managing method, applied to an electronic apparatus comprising a memory and a cache, comprising:
(a) transforming memory addresses for the memory to cache addresses of the cache;
(b) mapping a memory access range for a thread block to the cache addresses to generate a block access range;
(c) calculating block locality between the thread blocks according to the block access range; and
(d) allocating the thread blocks to a plurality of multi-processors depending on the block locality.

2. The thread block managing method of claim 1, wherein the step (b) calculates the memory access range according to only partial threads in each of the thread blocks.

3. The thread block managing method of claim 2, wherein the step (b) calculates the memory access range according to starting addresses and block sizes for the thread blocks.

4. The thread block managing method of claim 1, wherein the step (d) allocates a first thread block among the thread blocks with a second thread block among the thread blocks to one of the multi-processors, wherein the second thread block has a highest block locality with the first thread block.

5. The thread block managing method of claim 1, wherein the step (d) allocates a first thread block among the thread block with a second thread block among the thread block to one of the multi-processors, wherein block locality between other ones of the thread blocks and the first thread block in the same multi-processor is lower than a first predetermined value, and the block locality between the first thread block and the second thread block is lower than block locality between other ones of the thread blocks in other multi-processors and the first thread block.

6. The thread block managing method of claim 1, wherein each at least one of the thread blocks comprises a plurality of warps, wherein each of the warps comprises a plurality of threads, wherein the thread block managing method further comprises:
separating one of the thread blocks to a plurality of regions;
determining region vectors for the warps according to the regions;
separating each one of the regions to a plurality of sub-regions;
determining sub-region vectors for the warps according to the sub-regions; and
determining warp locality for the warps according to the region vectors and the sub-region vectors.

7. The thread block managing method of claim 6, wherein the electronic apparatus further comprises warp scheduler performing following steps:
dividing the warps in the multi-processor into an active group and a pending group, wherein the warps in the active group are executed before the warps in the pending group;
demoting the warp which is in the active group and reaches a latency stall over a predetermined level to the pending group; and
promoting the warp which is in the pending group and has the highest warp locality with other one of the warps in the active group.

8. A warp managing method, applied to warps in a thread block, wherein each of the warps comprises a plurality of threads, wherein the warp managing method comprises:
separating the thread block to a plurality of regions;
determining region vectors for the warps according to the regions;
separating each one of the regions to a plurality of sub-regions;
determining sub-region vectors for the warps according to the sub-regions;
determining warp locality for the warps according to the region vectors and the sub-region vectors;
dividing the warps into an active group and a pending group, wherein the warps in the active group are executed before the warps in the pending group;
demoting the warp which is in the active group and reaches a latency stall over a predetermined level to the pending group; and
promoting the warp which is in the pending group and has the highest warp locality with other one of the warps in the active group.

9. A non-transitory computer readable recording medium, comprising at least one program stored therein, a thread block managing method applied to an electronic apparatus comprising a memory and a cache can be performed if the program is executed, the thread block managing method comprising:
(a) transforming memory addresses for the memory to cache addresses of the cache;
(b) mapping a memory access range for a thread block to the cache addresses to generate a block access range;
(c) calculating block locality between the thread blocks according to the block access range; and
(d) allocating the thread blocks to a plurality of multi-processors depending on the block locality.

10. The non-transitory computer readable recording medium of claim 9, wherein the step (b) calculates the memory access range according to only partial threads in each of the thread blocks.

11. The non-transitory computer readable recording medium of claim 10, wherein the step (b) calculates the memory access range according to starting addresses and block sizes for the thread blocks.

12. The non-transitory computer readable recording medium of claim 9, wherein the step (d) allocates a first thread block among the thread blocks with a second thread block among the thread blocks to one of the multi-processors, wherein the second thread block has a highest block locality with the first thread block.

13. The non-transitory computer readable recording medium of claim 9, wherein the step (d) allocates a first thread block among the thread block with a second thread block among the thread block to one of the multi-processors, wherein block locality between other ones of the thread blocks and the first thread block in the same multi-processor is lower than a first predetermined value, and the block locality between the first thread block and the second thread block is lower than block locality between other ones of the thread blocks in other multi-processors and the first thread block.

14. The non-transitory computer readable recording medium of claim 9, wherein each at least one of the thread blocks comprises a plurality of warps, wherein each of the warps comprises a plurality of threads, wherein the thread block managing method further comprises:
separating one of the thread blocks to a plurality of regions;
determining region vectors for the warps according to the regions;
separating each one of the regions to a plurality of sub-regions;
determining sub-region vectors for the warps according to the sub-regions; and
determining warp locality for the warps according to the region vectors and the sub-region vectors.

15. The non-transitory computer readable recording medium of claim 14, wherein the electronic apparatus further comprises warp scheduler performing following steps:
dividing the warps in the multi-processor into an active group and a pending group, wherein the warps in the active group are executed before the warps in the pending group;
demoting the warp which is in the active group and reaches a latency stall over a predetermined level to the pending group; and
promoting the warp which is in the pending group and has the highest warp locality with other one of the warps in the active group.

16. A non-transitory computer readable recording medium, comprising at least one program stored therein, a warp managing method can be performed if the program is executed, the warp managing method comprising:
separating the thread block to a plurality of regions;
determining region vectors for the warps according to the regions;
separating each one of the regions to a plurality of sub-regions;
determining sub-region vectors for the warps according to the sub-regions; and
determining warp locality for the warps according to the region vectors and the sub-region vectors;
dividing the warps into an active group and a pending group, wherein the warps in the active group are executed before the warps in the pending group;
demoting the warp which is in the active group and reaches a latency stall over a predetermined level to the pending group; and
promoting the warp which is in the pending group and has the highest warp locality with other one of the warps in the active group.
